(19) United States
(12) Patent Application Publication
(10) Pub. No.: US 2011/0158405 A1
(43) Pub. Date: Jun. 30, 2011

(54) KEY MANAGEMENT METHOD FOR SCADA SYSTEM

(75) Inventors: Donghyun CHOI, Suwon-si (KR); Dongho Won, Suwon-si (KR); Seungjoo Kim, Suwon-si (KR); Jae-Cheol Ryou, Daejeon (KR)

(73) Assignee: The Industry & Academy Cooperation in Chungnam National University (IAC), Daejeon (KR)

(21) Appl. No.: 12/713,840

(22) Filed: Feb. 26, 2010

(30) Foreign Application Priority Data
Dec. 31, 2009 (KR) 2009-0135388
Jan. 22, 2010 (KR) 2010-0006103

(51) Int. Cl. H04L 9/00

(52) U.S. Cl. 380/44; 380/277

(57) ABSTRACT

Disclosed is a shared key management method for SCADA system in which a master terminal unit (MTU), a plurality of sub-master terminal units (sub-MTUs), and a plurality of remote terminal units (RTUs) are sequentially and hierarchically structured, comprising the steps of: generating shared keys of a group key in a tree structure by the MTU, the tree structure including a binary tree ranging from a root node corresponding to the MTU to intermediate nodes corresponding to the sub-MTUs; storing shared keys of descendant nodes and ancestor nodes of an intermediate node of a sub-MTU by the sub-MTU; and updating, upon updating of a shared key of an intermediate node, all shared keys of on-path nodes from the updated intermediate node to the root node, the shared keys of the on-path nodes being updated using their own shared keys and shared keys of off-path child nodes.

### CROSS-REFERENCE TO RELATED APPLICATION

This application claims priority to and the benefit of Korean Patent Application No. 2009-0135388, filed on Dec. 31, 2009 and Korean Patent Application No. 2010-0006103, filed on Jan. 22, 2010, the disclosures of which are incorporated herein by reference in its entirety.

### BACKGROUND

1. Field of the Invention

The present invention relates to a shared key management method and a session key generation method for a supervisory control and data acquisition (SCADA) system in which a master terminal unit (MTU), a plurality of sub-master terminal units (sub-MTUs), and a plurality of remote terminal units (RTUs) are configured in a sequential hierarchical structure, shared keys of a group key are generated in a tree structure and an RTU or a sub-MTU shares keys of ancestor nodes and descendant nodes of its corresponding node

Particularly, the present invention relates to a shared key management method and a session key generation method for a SCADA system in which a group key has a binary tree structure, and where, upon updating of a shared key of an intermediate node, all shared keys of on-path nodes between the intermediate node and a root node are updated using both themselves and shared keys of off-path child nodes.

2. Discussion of Related Art

In general, supervisory control and data acquisition (SCADA) systems are industrial control and supervisory systems which are used in infrastructures of a nation. That is, SCADA systems are computer systems which monitor and control processes of water resource facilities, energy facilities such as substations or power plants, gas or oil pipelines, and the like.

In the past, since SCADA systems were used in closed environments, they were designed without consideration of security functionality. However, as demand of connecting SCADA systems with open networks gradually increases, security of SCADA systems is becoming a bigger issue. Meanwhile, in order to enhance security of a SCADA system, it is essential to encrypt data and manage encryption keys.

Although key establishment for SCADA systems (SKE) and key management scheme for SCADA systems (SKMA) have been conventionally suggested as key management methods for SCADA systems, such key management methods fail to support broadcasting or multicasting communications. That is, in the SKE or SKMA method, it is essential to encrypt a message as many times as the number of units to which the message is to be sent using keys shared with the units. Since such a method requires management of thousands of units and applies a heavy load to a SCADA system, it is not actually suitable for communications.

In order to solve this problem, an improved key management technology for secure communications of a SCADA system through logic keys with a hierarchical structure was suggested by the applicant (refer to Korean Patent Application No. 2009-0004213 entitled “KEY MANAGEMENT METHOD AND COMMUNICATION METHOD FOR SECURE SCADA SYSTEM”).

As can be seen FIG. 5, in Korean Patent Application No. 2009-0004213, shared keys of a group key of a SCADA system are managed in a tree structure 1. Shared keys form a binary tree structure from a root node 2 corresponding to an MTU to intermediate nodes 3 corresponding to sub-MTUs. The tree structure has an n-array tree ranging from an intermediate node 3 to leaf nodes 4 corresponding to RTUs.

Then, if the shared key of an intermediate node 3 of a sub-MTU is changed, all the shared keys on the path from the intermediate node 3 to the root node 2 in the tree structure 1 should be updated. For example, if the shared key of an intermediate node K_{3,8} is changed, those of all the ancestor nodes K_{0,1}, K_{1,2}, and K_{2,4} should also be changed.

Then, the shared keys of all the on-path nodes K_{0,1}, K_{1,2}, K_{2,4}, and K_{3,8} are updated using those of their child nodes. For example, the shared key of the node K_{1,2} is calculated by hashing those of the nodes K_{2,3} and K_{2,4}. Then, an updated shared key K′_{2,4} is used as the shared key of the node key K_{2,4}.

However, according to Korean Patent Application No. 2009-0004213, for example, the intermediate nodes K_{3,1}, K_{3,2}, K_{3,3}, and K_{3,4} or the RTUs corresponding to the intermediate nodes should be informed of the updated shared key K′_{0,1} of the root node 2, and the sub-MTUs corresponding to the intermediate nodes K_{3,5} and K_{3,6} should also be informed of the updated shared keys K′_{0,1} and K′_{1,2}. Thus, the MTU should transmit the updated shared key K′_{0,1} or K′_{1,2} to the RTUs or the sub-MTUs. Then, the MTU should encrypt and transmit the updated shared key, and the RTUs or the sub-MTUs should decrypt the received shared keys. Accordingly, distribution of updated keys requires complex arithmetic operations and communications.

### SUMMARY OF THE INVENTION

The prevent invention has been made in an effort to solve the above-described problems associated with the prior art, and an object of the present invention is to provide a shared key management method and a session key generation method for SCADA system in which a group key has a binary tree structure and shared keys of on-path nodes from a sub-MTU node to a root node are updated using shared keys of off-path child nodes and their own shared keys.

It is another object of the present invention to provide a shared key management method and a session key generation method for SCADA system in which sub-MTUs or RTUs located at sibling nodes of on-path nodes or descendant nodes of the sibling nodes directly calculate updated shared keys of the parent node of the sibling nodes, i.e. an on-path node.

According to an aspect of the present invention for achieving the above object, there is provided a shared key management method for a supervisory control and data acquisition (SCADA) system in which a master terminal unit (MTU), a plurality of sub-master terminal units (sub-MTUs), and a plurality of remote terminal units (RTUs) are sequentially and hierarchically structured, comprising the steps of: (1) generating shared keys of a group key in a tree structure by the MTU, the tree structure including a binary tree ranging from a root node corresponding to the MTU to intermediate nodes corresponding to the sub-MTUs; (2) storing shared keys of descendant nodes and ancestor nodes of an intermediate node of a sub-MTU by the sub-MTU; and (3) updating, upon updating of a shared key of an intermediate node, all shared keys of on-path nodes from the updated intermediate node to the root node, the shared keys of the on-path nodes being updated using their own shared keys and shared keys of off-path child nodes.

In the step (3), a sub-MTU corresponding to one of the sibling nodes of the on-path nodes or the sub-MTU corresponding to one of the descendant nodes of the sibling nodes calculates the updated shared keys of the parent nodes of the sibling nodes by itself and receives the shared keys of the ancestor nodes of the parent nodes from the MTU.

The tree structure is an n-array tree ranging from the intermediate node of the sub-MTU to the leaf nodes of the RTUs belonging to the sub-MTU in the step (1) and the RTUs store the shared keys of the ancestor nodes of their leaf nodes in the step (2).

In the step (3), the RTUs corresponding to the descendant nodes of the sibling nodes of the on-path nodes directly calculate the updated shared keys of the parent nodes of the sibling nodes and receive the shared keys of the ancestor nodes of the parent nodes from the MTU or the sub-MTU.

In the step (2), the shared keys are received from the MTU and then are stored.

In the step (3), if an RTU is added or deleted, the shared key of an intermediate node of a sub-MTU to which the RTU is connected is updated.

The shared keys of the on-path nodes are calculated by hashing their own shared keys and the shared keys of off-path child nodes.

According to another aspect to the present invention, there is provided a recording medium readable by a computer in which the shared key management method for a SCADA system is recorded.

According to another aspect of the present invention for achieving the above object, there is provided a session key generation method for a supervisory control and data acquisition (SCADA) system in which a master terminal unit (MTU), a plurality of sub-master terminal units (sub-MTUs), and a plurality of remote terminal units (RTUs) are sequentially and hierarchically structured, comprising the steps of: (1) generating shared keys of a group key in a tree structure by the MTU, the tree structure including a binary tree ranging from a root node corresponding to the MTU to intermediate nodes corresponding to the sub-MTUs; (2) storing shared keys of descendant nodes and ancestor nodes of an intermediate node of a sub-MTU by the sub-MTU; (3) updating, upon updating of a shared key of an intermediate node, all shared keys of on-path nodes from the updated intermediate node to the root node, the shared keys of the on-path nodes being updated using their own shared keys and shared keys of off-path child nodes; and (4) selecting a node of the tree structure and generating a session key for communication with a sub-MTU and an RTU corresponding to the descendant nodes of the selected node using the shared key of the selected node.

The tree structure is an n-array tree ranging from the intermediate node of the sub-MTUs to the leaf nodes of the RTUs belonging to the sub-MTU in the step (1), the RTUs store the shared keys of the ancestor nodes of their leaf nodes in the step (2), and the sub-MTUs generate session keys for communication with the RTUs using the shared keys of their intermediate keys.

The session keys are generated by hashing values obtained by combining the shared keys, timestamps, and sequence numbers.

As mentioned above, according to a shared key management method and a session key generation method for a SCADA system of the present invention, a message is encrypted to support multicasting and broadcasting, thereby cutting down the amount of operations for distribution of keys and the amount of communications.

Furthermore, according to a shared key management method and a session key generation method for a SCADA system of the present invention, RTUs or sub-MTUs do not need to perform communications and operations of receiving all shared keys from an MTU and decrypting the received shared keys but only directly calculate the updated shared keys through a simple Hash function, thereby minimizing the amount of calculations of the RTUs which is restricted due to performance.

### BRIEF DESCRIPTION OF THE DRAWINGS

The above and other objects, features and advantages of the present invention will become more apparent to those of ordinary skill in the art by describing in detail an exemplary embodiment thereof with reference to the accompanying drawings, in which:

FIG. 1 is a view illustrating the entire configuration of a SCADA system for carrying out the present invention;

FIG. 2 is a flowchart illustrating a shared key management method for SCADA system according to an embodiment of the present invention;

FIG. 3 is a view exemplifying a tree structure of a group key generated according to the embodiment of the present invention;

FIG. 4 is a view illustrating an example of updating shared keys of a group key of a tree structure according to the embodiment of the present invention; and

FIG. 5 is a view exemplifying a tree structure in which shared keys of a group key are conventionally updated.

### DETAILED DESCRIPTION OF EXEMPLARY EMBODIMENTS

Hereinafter, exemplary embodiments of the present invention will be described below in detail with reference to the accompanying drawings.

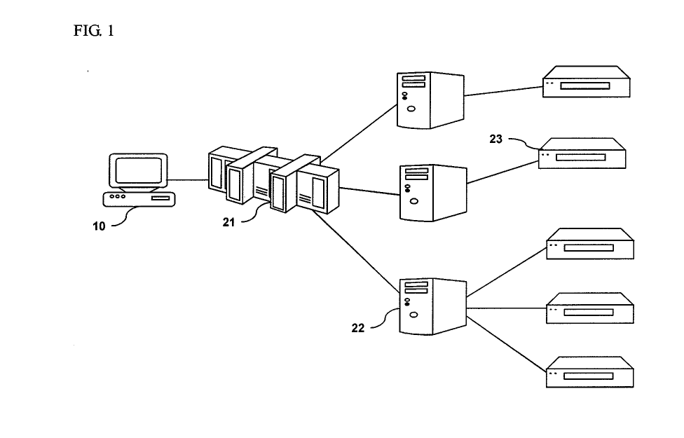

First, an example of the entire configuration of a SCADA system for carrying out the present invention will be described with reference to FIG. 1.

As can be seen in FIG. 1, the SCADA system for carrying out the present invention includes a human-machine interface (HMI) 10, a master terminal unit (MTU) 21, a plurality of sub-master terminal units (sub-MTUs) 22, and a plurality of remote terminal units (RTUs) 23. In particular, the MTU 21, the sub-MTUs 22, and the RTUs 23 have a sequential hierarchical structure.

The HMI 10 is a terminal unit which displays process data of infrastructures to an operator and through which the operator monitors and controls the infrastructures. For this purpose, the HMI 10 is constituted by a type of terminal unit having a computing function.

The RTUs are terminal units which are directly installed in infrastructures to collect and transmit process data and perform their functions according to control instructions. Since the infrastructures to which the SCADA system is applied are distributed over a wide region, the RTUs are also widely scattered.

The sub-MTUs 22 communicate with and control certain RTUs 23. The MTU 21 is a unit which collects and controls process data as a whole. That is, the MTU 21 controls the sub-MTUs 22 and monitors and controls the RTUs 23 through the sub-MTUs 22.

Meanwhile, session keys are used for encrypted communications among the MTU 21, the sub-MTUs 22, and the RTUs 23. That is, a session key is generated between a transmission terminal and a reception terminal so as to be distributed to them. The transmission terminal encrypts a message to be sent to a session key, and the reception terminal receives the encrypted message and decrypts the session key.

Session keys are keys used for specific sessions for transmitting and receiving a message, and may be different according to their sessions. Even if a session key is exposed, the other sessions are secure. However, session keys are generated using shared keys shared by terminals. That is, session keys are generated by adding timestamps, sequence numbers, identifiers of units to shared keys. Thus, management of shared keys is most important for secure communications.

According to the shared key management method for a SCADA system for carrying out the present invention, one logical structure is managed by a MTU 21 as a whole. That is, according to the embodiment of the present invention, the MTU 21 generates shared keys and transmits them to the sub-MTUs 22 or the RTUs 23. The MTU 21 directly manages the entire shared keys.

Meanwhile, if an RTU 23 is deleted from or added to the SCADA system, all the shared keys which have been shared with the RTU 23 should be updated for their protection. Thus, the MTU 21 updates some of the shared keys and transmits the updated shared keys to the sub-MTUs 22 and the RTUs 23. Then, the sub-MTUs 22 or the RTUs 23 may not receive all the updated shared keys but may directly calculate some of the shared keys.

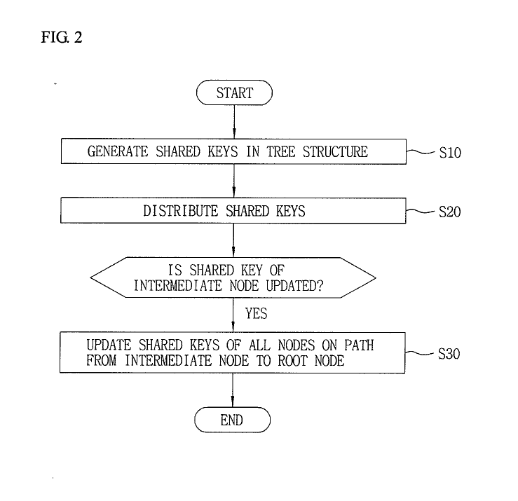

Now, a shared key management method for a SCADA system according to an embodiment of the present invention will be described with reference to FIG. 2.

As can be seen in FIG. 2, the key management method according to the embodiment of the present invention comprises a step S10 of generating shared keys in a tree structure, a step S20 of distributing the shared keys, and a step S30 of updating the shared keys.

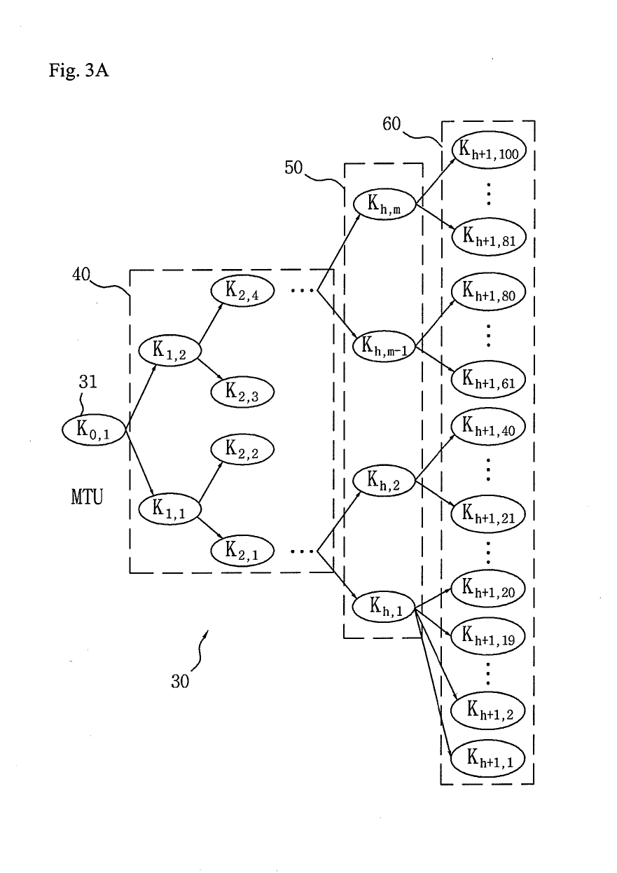

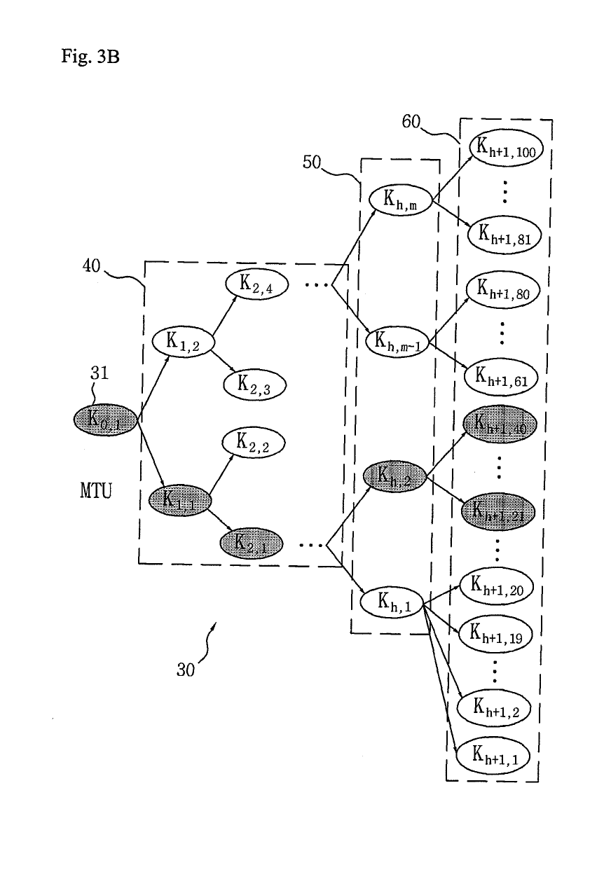

First, the MTU 21 generates shared keys of a group key in a tree structure (S10). As can be seen in FIG. 3A, the root node 31 of the tree structure 30 corresponds to the MTU 21. The intermediate nodes 50 correspond to the sub-MTUs 22 and the leaf nodes 60 correspond to the RTUs 23.

Meanwhile, a binary tree structure is formed between the root node 31 and the intermediate nodes 50. The nodes between the root node 31 and the intermediate nodes 50 will be referred to as “general nodes” 40.

The child nodes 60 of the intermediate node 50 of one sub-MTU 22 are nodes 60 corresponding to the RTUs 23 connected to the sub-MTU 22. That is, the tree whose apex is the intermediate node 50 is an n-array tree.

Shared keys are generated at the nodes of the tree structure 30. An example of generating shared keys is as follows.

First, the MTU 21 generates a plurality of secret keys and allocates them to the RTUs 23. The secret keys allocated to the RTUs 23 become the shared keys of the leaf nodes 60 of the tree structure 30. For example, the secret keys K_{h+1,1}, K_{h+1,2}, . . . , K_{h+1,100} allocated to the RTUs R₁, R₂, . . . , R₁₀₀ become the shared keys of the leaf nodes 60 of the tree structure 30.

Next, the shared keys of the nodes of the tree structure 30 are generated using the shared keys of their child nodes. For example, the shared keys of the nodes are generated by hashing the shared keys of all the child nodes.

The shared keys of the intermediate nodes 50 are generated by hashing the shared keys of their child nodes, i.e. the leaf nodes 60.

That is, the shared key K_{i-1,|j/n| if (i≦i≦log}_{ₙ} _{m-1,1≦j≦m)} of an intermediate node is generated by hashing shared keys K_{i,j if (i≦i≦log}_{ₙ} _{m-1,1≦}_{_{.}}_{≦m)} of m leaf nodes. This can be expressed by Equation 1.

$${K}_{i - 1 , [ \frac{j}{n} ]} = H ( H ( {K}_{i , j} ) , H ( {K}_{i , j + 1} ) , … , H ( {K}_{i , j + n - 1} ) ) \qquad Equation 1$$

if (1≦i≦logₙ m−1,1≦j≦m)

Here, n denotes the number of RUTs connected to a sub-MTU and m denotes the number of the number of sub-MTUs.

For example, referring to FIG. 3, a shared key K_{h,1} is generated by hashing K_{h+1,1}, K_{h+1,2}, . . . , K_{h+1,20}.

Meanwhile, a binary tree is formed between a root node 31 and an intermediate node 50. The shared keys of the nodes in the binary tree is generated by hashing the shared keys (or hashed values) of two child nodes. This can be expressed by Equation 2.

$${K}_{i 1 , [ \frac{j}{2} ]} = H ( H ( {K}_{i , j} ) , H ( {K}_{i , j + 1} ) ) if ( 1 \leq i \leq h - 1 , 1 \leq j \leq m ) \qquad Equation 2$$

Here, m denotes the number of sub-MTUs and h is equal to 1+log₂ m.

For example, referring to FIG. 3a, a shared key K_{1,1} is generated by hashing the shared keys K_{2,1} and K_{2,2}. Thus, a shared key structure in a binary tree form is formed though Equation 2, and the shared key K_{0,1} of the root node is also generated.

Next, an RTU 23 or a sub-MTUs 22 receives and stores the shared keys of the ancestor nodes and descendant nodes of a node corresponding it (S20).

That is, the sub-MTU 22 stores the shared keys of the descendant nodes and ancestor nodes of its intermediate node 50 in the tree structure 30. For example, referring to FIG. 3b, the sub-MTU K_{h,2} corresponds to the intermediate node K_{h,2}. The ancestor nodes of the intermediate node K_{h,2} are K_{0,1}, K_{1,1}, K_{2,1}, . . . , and the descendant nodes of the intermediate node K_{h,2} are K_{h+1,21}, K_{h+1,22}, . . . , K_{h+1,40}. Thus, the sub-MTU K_{h,2} holds the shared key K_{h,2} of its intermediate node and the shared keys of its ancestor nodes K_{0,1}, K_{1,1}, K_{2,1}, . . . , and the shared keys of its descendant nodes K_{h+1,21}, K_{h+1,22}, . . . , K_{h+1,40}. Referring to FIG. 3B, the sub-MTU K_{h,2} holds the shared keys indicated by grey color.

An RTU 23 stores the shared key of the ancestor nodes of its leaf node 50 in the tree structure 30. Then, since the RTU 23 has no descendant node, it only stores the shared keys of its ancestor nodes. For example, referring to FIG. 3a, the RTU K_{h+1,2} corresponds to a leaf node K_{h+1,2}. The ancestor nodes of the leaf node K_{h+1,2} are K_{0,1}, K_{1,1}, K_{2,1}, . . . , K_{h,1}. Thus, the RTU K_{h+1,2} holds the shared key K_{h+1,2} of its leaf node, and the shared keys K_{0,1}, K_{1,1}, K_{2,1}, . . . , K_{h,1} of its ancestor nodes.

That is, when the number of sub-MTUs 22 is m, (1+log₂ m) shared keys and shared keys whose number is that of the RTUs 22 belonging to the sub-MTU 22 are stored. The RTU 23 stores (2+log₂ m) shared keys by adding its shared key (or secret key) to the number of shared keys corresponding to its ancestor nodes.

Next, if the shared key of an intermediate node is updated, all the nodes (hereinafter, referred to as “on-path nodes”) on the path from the intermediate node to the root node are updated, and the shared keys of the on-path nodes are updated using its shared key and the off-path child nodes.

As an example, if an RTU 23 is added or deleted, the shared keys of an intermediate node 50 corresponding to a sub-MTU 22 connected to the RTU 23 and the ancestor nodes of the intermediate node 50 are updated. If one RTU 23 is deleted (withdrawn), since the deleted RTU 23 recognizes the shared keys of the ancestor nodes of the leaf node 60 corresponding to it in the tree structure 30, the shared keys of the ancestor nodes are assumed to be exposed. Therefore, all the shared keys of the ancestor nodes of the leaf node 60 should be updated.

If an RTU 23 is added, it receives its own secret key generated by the MTU 21. The shared key of the intermediate node 50 corresponding to the sub-MTU (connected to the added RTU) as well as the secret key of the added RTU 23 is updated. Therefore, all the shared keys of the ancestor nodes of the sub-MTU are updated, considering updating of the shared key of the sub-MTU.

If an RTU 23 is added or deleted, the MTU 21 adds or deletes the node 60 corresponding to the added or deleted RTU to and from the node 50 corresponding to the sub-MTU 22 to which the added or deleted RTU 23 is connected.

Since the tree structure of the intermediate node 50 and the leaf nodes 60 formed an n-array tree, the number of the child nodes of the intermediate node 50 may be plural. Thus, if an RTU 23 is added or deleted, a leaf node 60 is added or deleted to and from the intermediate node 50. The other nodes of the tree structure 30 are not changed.

For example, referring to FIG. 3a, if an RTU R₁₀₀ is deleted, the leaf node _{Kh+1,100} corresponding to it is deleted from the intermediate node K_{h,m}. Referring to FIG. 3a again, if an RTU R₁₀₁ is added, the leaf node K_{h+1,101} corresponding to it is added to the intermediate node K_{h,m}. The other tree structure 30 is not changed in FIG. 3A.

Here, updating of shared keys is not limited to addition or deletion of an RTU 23. The key of a node should also be updated when a sub-MTU is changed (deleted or added), or when the node is attacked by a malicious attacker. The present invention is also applied to those cases.

The shared keys of the on-path nodes from the added or deleted leaf node to the root node are updated.

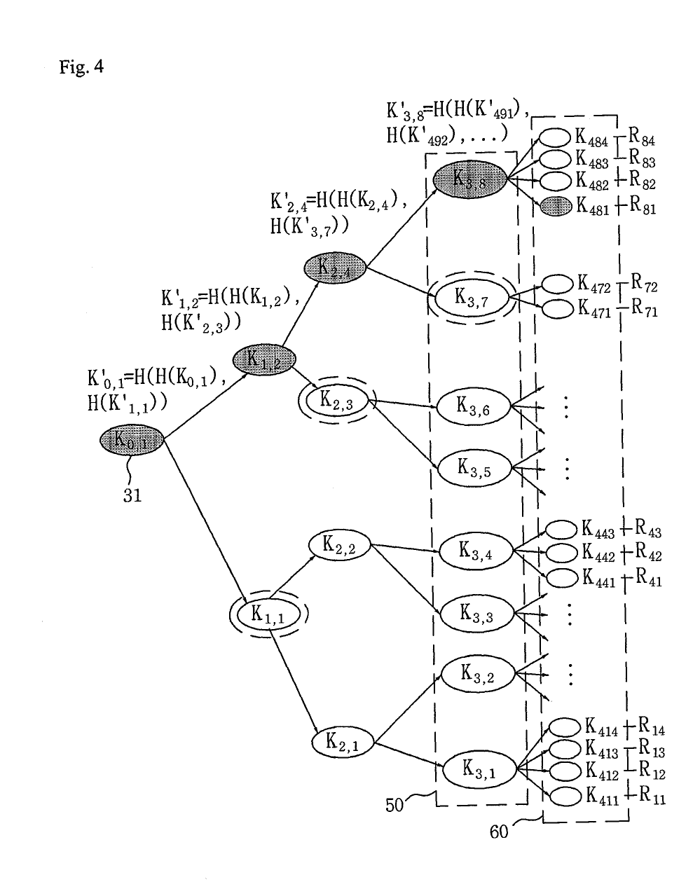

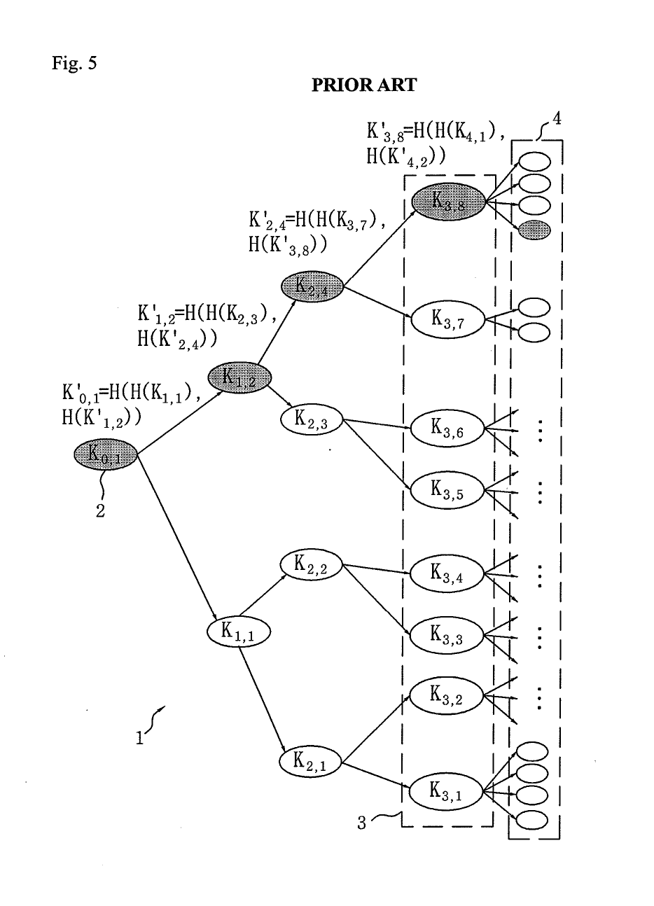

A method of updating shared keys will be described in detail with reference to FIG. 4. FIG. 4 illustrates an example of updating shared keys of a group key when an RTU R₈₁ is withdrawn (deleted).

First, an RTU 23 is added or deleted, the MTU 21 updates the shared keys of the on-path nodes from the intermediate node of the sub-MTU to which the RTU 23 belongs to the root node.

Then, the shared keys of the on-path nodes are calculated using its shared key and the shared keys of the child nodes. For example, they are calculated using Hash function as in Equation 3.

$${K}_{i - 1 , [ \frac{j}{2} ]} = H ( H ( {K}_{i - 1 , [ \frac{j}{2} ]} ) , H ( {K}_{i , k} ) ) \qquad Equation 3$$

if (1≦i≦h−1,1≦j≦m,k=j or j÷1)

Here, m denotes the number of sub-MTUs, h is equal to 1+log₂ m, and K_{i,k} are off-path child nodes (child nodes of K_{i-1,j/2}).

In the example of FIG. 4, if the RTU R₈₁ is deleted, the leaf node corresponding to the RTU R₈₁ is K₄₈₁ and the intermediate node connected (belonging) to K₄₈₁ is K_{3,8}. All the shared keys of the on-path nodes K_{3,8}, K_{2,4}, K_{1,2}, and K_{0,1} from the intermediate node K_{3,8} to the root node K_{0,1} should be updated.

The RTUs 23 or the sub-MTUs 22 directly calculate or receive the updated shared keys and store them. That is, a sub-MTU 22 corresponding to one of the sibling nodes of the on-path nodes or the sub-MTUs 22 corresponding to the descendant nodes of the sibling nodes directly calculate the updated shared keys of the parent nodes of the sibling nodes and receive the shared keys of the ancestor nodes of the parent nodes from the MTU 21.

The RTUs 23 corresponding to the descendant nodes of the sibling nodes of the on-path nodes directly calculate the updated shared keys of the parent nodes of the sibling nodes and receive the shared keys of the ancestor nodes of the parent nodes from the MTU 21 or the sub-MTUs 22.

In an example of FIG. 4, one of the on-path nodes is K_{1,2}, and its sibling node is K_{1,1}. The sibling node K_{1,1} and the sub-MTUs 22 located at the descendant nodes of the sibling node are the sub-MTUs SUB₁, SUB₂, SUB₃, and SUB₄ corresponding to the intermediate nodes of K_{3,1}, K_{3,2}, K_{3,3}, and K_{3,4}. The RTUs 23 located at the sibling node K_{1,1} and the descendant nodes of the sibling node are R₁₁, R₁₂, R₁₃, . . . , R₄₂, R₄₃ corresponding to the leaf nodes of K₄₁₁, K₄₁₂, K₄₁₃, . . . , K₄₄₂, K₄₄₃. The sub-MTUs or the RTUs directly calculate the updated shared key of the parent node of the sibling node K_{1,1}, i.e. K_{0,1} using Equation 3.

In Equation 3, the shared key of the parent node are obtained by hashing the sibling node and the parent nodes of the sibling node. Thus, since the sub-MTUs or the RTUs corresponding to the sibling nodes and the descendant nodes of the sibling nodes know both the shared keys of the sibling nodes and the prior shared keys of the parent nodes, the shared keys of the parent nodes may be calculated using Equation 3.

Meanwhile, the sibling nodes of the on-path node and the sub-MTUs 22 or the RTUs 23 corresponding to the sibling nodes cannot know the shared keys of the ancestor nodes of the sibling nodes. In the example of FIG. 4, the sub-MTUs SUB₅ and SUB₆ corresponding to the descendant nodes K_{3,5} and K_{3,6} of one node K_{2,3} of the sibling nodes of the on-path nodes cannot directly calculate the updated shared key of K_{0,1} which is an ancestor node of their parent node K_{1,2}. The updated shared key of K_{0,1} is updated by hashing the shared key of the node K_{1,1}. Thus, such shared keys should be received from the MTU 21.

Then, the MTU 21 encrypts the updated shared key using the prior shared key and multicasts it to the RTU 23 or the sub-MTU 22, and the RTU 23 or the sub-MTU 22 receives and decrypts the encrypted shared key and stores it.

As mentioned above, in a SCADA system, all the keys on the path from a removed user node (a node corresponding to an RTU) to a root node. Thus, even when an RTU is withdrawn, all keys exposed to the RTU are updated, thereby preventing security problems.

Hereinafter, a session key generation method and a message communication method for a SCADA system according to the present invention will be described.

A session key is generated using a shared key. Thus, a method of generating, storing, and updating a shared key is as mentioned above.

After a group key is initially distributed, nodes are installed at remote places such as power plants or substations. If a root node, i.e. the MTU communicates with an RTU R₁₁ corresponding to the node after installation of the node, a session key is generated to encrypt data as in Equation 4.

S_{0,211}=H(K₂₁₁,C₂₁₁) Equation 4

As in Equation 4, a session value is generated by hashing the key K₄₁₁ of the RTU R₁₁ and the counter value C₂₁₁. The process is identically performed at the MTU and the RTU R₁₁ to generate a same session key. Once the session key is generated, the data entering and exiting the session is encrypted by a session key_{0,211} as in Equation 5 and then is transmitted. If the session is completed, the root node, i.e. the MTU and the RTU R₁₁ increases the counter value by one as in Equation 6.

E_{S}_{_{0,211}}(D) Equation 5

C₂₁₁=C₂₁₁+1 Equation 6

If the root node, i.e. the MTU intends to broadcast information to nodes, it generates a key to be used in broadcasting using the shared key K_{0,1} and the counter value C₀ as in Equation 7.

S_{b,o}=H(K₀,C₀)

As an alternative example, the MTU 21 selects a node of the tree structure 30, and generates a session key for communication with the sub-MTUs and the RTUs 23 corresponding to the descendant nodes of a selected node as the shared key of the selected node.

For example, a message obtained by generating a session key using the shared key K1,1 and encrypted as the session key by the MTU 21 transmits the sub-MTUs SUB₁, SUB₂, SUB₃, and SUB₄ and the RTUs R₁₁, R₁₂, R₁₃, R₁₄, . . . , R₄₁, R₄₂, R₄₃. Then, since the sub-MTUs and the RTUs share the shared key K_{1,1}, a session key is generated to decrypt the message.

Thus, the descendant terminals corresponding to the tree structure may be grouped to set an encryption session through the shared key of the tree structure 30.

The present invention is useful in developing a system for transmitting and receiving a message through encryption communications in a SCADA system. In particular, the present invention is useful in developing an effective encryption communication system that enables broadcasting or multicasting communications through encryption communications in a SCADA system.

It will be apparent to those skilled in the art that various modifications can be made to the above-described exemplary embodiment of the present invention without departing from the spirit or scope of the present invention. Thus, it is intended that the present invention covers all such modifications provided they come within the scope of the appended claims and their equivalents.

What is claimed is:

1. A shared key management method for a supervisory control and data acquisition (SCADA) system in which a master terminal unit (MTU), a plurality of sub-master terminal units (sub-MTUs), and a plurality of remote terminal units (RTUs) are sequentially and hierarchically structured, comprising the steps of:
(1) generating shared keys of a group key in a tree structure by the MTU, the tree structure including a binary tree ranging from a root node corresponding to the MTU to intermediate nodes corresponding to the sub-MTUs;
(2) storing shared keys of descendant nodes and ancestor nodes of an intermediate node of a sub-MTU by the sub-MTU; and
(3) updating, upon updating of a shared key of an intermediate node, all shared keys of on-path nodes from the updated intermediate node to the root node, the shared keys of the on-path nodes being updated using their own shared keys and shared keys of off-path child nodes.

2. The shared key management method of claim 1, wherein, in the step (3), a sub-MTU corresponding to one of the sibling nodes of the on-path nodes or a sub-MTU corresponding to one of the descendant nodes of the sibling node calculates the updated shared keys of the parent nodes of the sibling nodes by itself and receives the shared keys of the ancestor nodes of the parent nodes from the MTU.

3. The shared key management method of claim 1, wherein the tree structure is an n-array tree ranging from the intermediate node of the sub-MTU to the leaf nodes of the RTUs belonging to the sub-MTU in the step (1) and the RTUs store the shared keys of the ancestor nodes of their leaf nodes in the step (2).

4. The shared key management method of claim 2, wherein, in the step (3), the RTUs corresponding to the descendant nodes of the sibling nodes of the on-path nodes calculate the updated shared keys of the parent nodes of the sibling nodes by themselves and receive the shared keys of the ancestor nodes of the parent nodes from the MTU or the sub-MTU.

5. The shared key management method of claim 1, wherein, in the step (2), the shared keys are received from the MTU and then are stored.

6. The shared key management method of claim 1, wherein, in the step (3), if an RTU is added or deleted, the shared key of an intermediate node of a sub-MTU to which the RTU is connected is updated.

7. The shared key management method of claim 1, wherein the shared keys of the on-path nodes are calculated by hashing their own shared keys and the shared keys of their off-path child nodes.

8. A recording medium readable by a computer in which the shared key management method for a SCADA system of claim 1 is recorded.

9. A session key generation method for a supervisory control and data acquisition (SCADA) system in which a master terminal unit (MTU), a plurality of sub-master terminal units (sub-MTUs), and a plurality of remote terminal units (RTUs) are sequentially and hierarchically structured, comprising the steps of:
(1) generating shared keys of a group key in a tree structure by the MTU, the tree structure including a binary tree ranging from a root node corresponding to the MTU to intermediate nodes corresponding to the sub-MTUs;
(2) storing shared keys of descendant nodes and ancestor nodes of an intermediate node of a sub-MTU by the sub-MTU;
(3) updating, upon updating of a shared key of an intermediate node, all shared keys of on-path nodes from the updated intermediate node to the root node, the shared keys of the on-path nodes being updated using their own shared keys and shared keys of off-path child nodes; and
(4) selecting a node of the tree structure and generating a session key for communication with a sub-MTU and an RTU corresponding to the descendant nodes of the selected node using the shared key of the selected node.

10. The session key generation method of claim 9, wherein the tree structure is an n-array tree ranging from the intermediate node of the sub-MTUs to the leaf nodes of the RTUs belonging to the sub-MTU in the step (1), the RTUs store the shared keys of the ancestor nodes of their leaf nodes in the step (2), and the sub-MTUs generate session keys for communication with the RTUs using the shared keys of their intermediate keys.

11. The session key generation method of claim 10, wherein the session keys are generated by hashing values obtained by combining the shared keys, timestamps, and sequence numbers.
